(19) United States
(12) Patent Application Publication
(10) Pub. No.: US 2019/0126712 A1
(43) Pub. Date: May 2, 2019

(54) ROUGH ROAD DETECTION AS AN INPUT TO INDIRECT AIR CONSUMPTION MEASUREMENT

(71) Applicant: Bendix Commercial Vehicle Systems LLC, Elyria, OH (US)

(72) Inventors: Thomas S. Miller, JR., Lagrange, OH (US); Joseph M. Macnamara, Ashland, OH (US)

(73) Assignee: Bendix Commercial Vehicle Systems LLC, Elyria, OH (US)

(21) Appl. No.: 15/796,957

(22) Filed: Oct. 30, 2017

(51) Int. Cl. B60G 17/0165; B60G 17/015; B60G 17/019; B60G 17/018

(52) U.S. Cl. CPC B60G 17/0165; B60G 17/0155; B60G 17/019; B60G 2500/30; B60G 2400/208; B60G 2500/02; B60G 17/018

(57) ABSTRACT

When a vehicle is determined to be traveling on a rough road, wherein increased air consumption is expected by vehicle components, a warning threshold that triggers an alert regarding excessive air consumption is increased. A duty cycle for an on-board air compressor is also increased to a level just below the increased warning threshold. In this manner, the air compressor duty cycle can be increased to meet the increased air pressure demand caused by the rough road conditions without triggering false positive alerts or distracting the driver.

### BACKGROUND

The present application finds particular application in commercial vehicle brake systems. However, it will be appreciated that the described techniques may also find application in other vehicle safety systems, or other vehicle braking systems.

Conventional systems and methods for monitoring air supply in a brake system involve a pneumatic suspension that communicates with an ABS unit. The motion of the vehicle wheel is monitored such that the suspension air supply is blocked when the vehicle is in motion in order to reduce air consumption.

Low air pressure in commercial vehicles can detrimentally impact vehicle stopping distance during emergency brake events. In a scenario in which a faulty component (e.g., a leaky valve or the like) is present, excessive air consumption can occur during non-braking events. Although duty-cycle monitoring can be employed to detect such excessive air consumption, there are instances where increased air consumption as monitored by a conventional duty cycle-based compressor model may incorrectly detect excessive air consumption (false positive alerts), such as when a vehicle is driving on a rough or unpaved road.

The present innovation provides new and improved systems and methods that facilitate using wheel speed sensor signals to determine a rough road condition in which high air consumption can be assumed and adjusting compressor duty cycle in response thereto, which overcome the above-referenced problems and others.

### SUMMARY

In accordance with one aspect, a system that facilitates adjusting air compressor duty cycle for a vehicle on a rough road, comprises one or more air suspension bags that provide load-leveling capability for the vehicle, an air compressor having a first duty cycle and providing air to the one or more air suspension bags, and a processor configured to receive an indication that the vehicle is on a rough road and increase a warning threshold above which a driver is alerted to an over-threshold duty-cycle.

In accordance with another aspect, a method for adjusting air compressor duty cycle for a vehicle on a rough road comprises receiving an indication that the vehicle is on a rough road, increasing a warning threshold above which a driver is alerted to an over-threshold duty-cycle.

A controller configured to adjust air compressor duty cycle for a vehicle on a rough road, comprises at least one processor configured to receive an indication that the vehicle is on a rough road, increase a warning threshold above which a driver is alerted to an over-threshold duty-cycle.

In accordance with another aspect, an apparatus for adjusting air compressor duty cycle for a vehicle on a rough road comprises receiving means for receiving an indication that the vehicle is on a rough road, means for increasing a warning threshold above which a driver is alerted to an over-threshold duty-cycle.

In accordance with another aspect, a system that facilitates adjusting air compressor duty cycle for a vehicle on a rough road comprises one or more air suspension bags that provide load-leveling capability for the vehicle, and a height control device configured to transmit a control signal to the one or more air suspension bags. The height control device is further configured to receive an indication that the vehicle is on a rough road, and adjust an amount of dead band in the control signal in order to control a number of times the one or more air suspension bags are activated and deactivated during a period of time of receiving the indication that the vehicle is on the rough road.

One advantage is that vehicle stability is improved.

Another advantage is that vehicle safety is improved.

Still further advantages of the subject innovation will be appreciated by those of ordinary skill in the art upon reading and understanding the following detailed description.

### BRIEF DESCRIPTION OF THE DRAWINGS

The innovation may take form in various components and arrangements of components, and in various steps and arrangements of steps. The drawings are only for purposes of illustrating various aspects and are not to be construed as limiting the invention.

FIG. 1 illustrates a system that facilitates adjusting air compressor duty cycle for a vehicle on a rough road, in accordance with one or more features described herein.

FIG. 2 illustrates a method for adjusting air compressor duty cycle for a vehicle on a rough road, in accordance with one or more features set forth herein.

FIG. 3 illustrates a first graph representing speed and pressure at a wheel end as a function of time, such as can be detected by the described systems and methods and used to determine whether the vehicle is on a rough surface or a smooth surface.

FIG. 4 illustrates a second graph representing speed and pressure at a wheel end as a function of time, such as can be detected by the described systems and methods and used to determine whether the vehicle is on a rough surface or a smooth surface.

### DETAILED DESCRIPTION

The foregoing problems are overcome by the herein-described systems and methods, which facilitate automatically adjusting an air compressor duty cycle setting when a vehicle is determined to be on a rough road. The described systems and methods use rough road detection as an input for an indirect air consumption measurement. In one example, an antilock braking system (ABS) detects a rough road condition by monitoring wheel speed sensor information. If the ABS detects a rough road condition, it is assumed that the vehicle's air suspension system and other suspension components have increased air usage. The rough road indication is passed from the ABS to an algorithm or module that adjusts an indirect air consumption measurement that may be calculated by another on-board component, such as an electronic air control device (EAC) that controls an air compressor. In this manner, the indirect air consumption measurement is made more accurate.

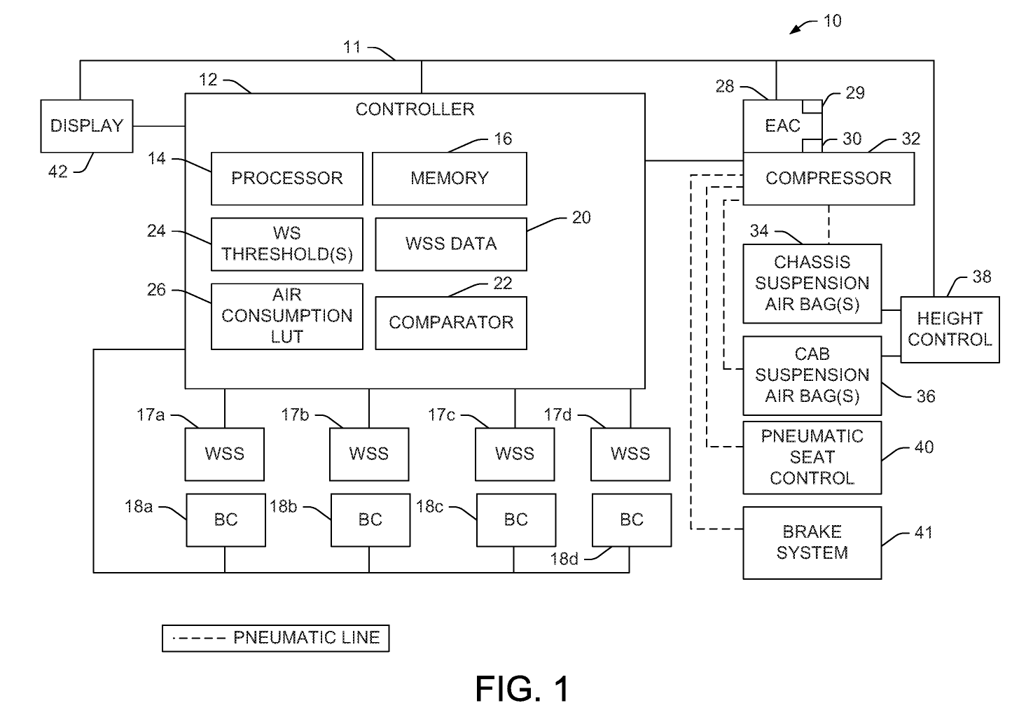

FIG. 1 illustrates a system 10 that facilitates adjusting air compressor duty cycle for a vehicle on a rough road, in accordance with one or more features described herein. The system includes a serial bus 11 via which various components of the system communicated. Coupled to the serial bus is a controller 12, which comprises processor 14 that executes, and a memory 16 that stores, computer-executable instructions (e.g., modules, routines, programs, applications, etc.) for performing the various methods, techniques protocols, etc., described herein. The memory 16 may include volatile memory, non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), variants of the foregoing memory types, combinations thereof, and/or any other type(s) of memory suitable for providing the described functionality and/or storing computer-executable instructions for execution by the processor 14. Additionally, “module,” as used herein denotes a set of computer-executable instructions (e.g., a routine, sub-routine, program, application, or the like) that is persistently stored on the computer-readable medium or memory for execution by the processor.

The system 10 includes a plurality of wheel speed sensors 17a, 17b, 17c, 17d. There may be more or fewer wheel speed sensors depending on the configuration of the commercial vehicle, such as whether the commercial vehicle is a tractor trailer combination vehicle. Each wheel speed sensor 17a, 17b, 17c, 17d is installed as part of the braking system at each individual wheel end, each of which comprises at least one brake component (BC) 18a, 18b, 18c, 18d. In one embodiment, there may be one wheel speed sensor per wheel end. In another embodiment, the wheel speed sensors may be installed on only one axle of a tandem axle tractor or trailer. The wheel speed sensor 17a, 17b, 17c, 17d is installed proximate to an associated exciter ring at each wheel end (not shown).

Each wheel speed sensor 17a, 17b, 17c, 17d has a nominal resistance value. For example, each wheel speed sensor 17a, 17b, 17c, 17d may have a nominal resistance value of about 1200 ohms, representing the resistance of the wheel speed sensor when exposed to a temperature of about 25° C. Each wheel speed sensor 17a, 17b, 17c, 17d transmits a wheel speed signal at a frequency indicative of the speed of rotation of the wheel end. The amplitude of the wheel speed signal is indicative of the distance the wheel speed sensor 17a, 17b, 17c, 17d is from the associated exciter ring. In one embodiment, the wheel speed sensors 17a, 17b, 17c, 17d may be of the type WS-24™ wheel speed sensors from Bendix Commercial Vehicle Systems LLC of Elyria, Ohio.

A rough road condition can be detected by monitoring changes in wheel speed acceleration. In one approach, dispersion analysis is used to produce a signal which increases in magnitude as road roughness increases. Dispersion measures the spread of a data set relative to its mean. First, the absolute deviations of two wheel accelerations are computed. Afterwards, absolute deviations are summed over a number of samples. The higher of the driven and non-driven wheel deviations will be used in the summation. After an acceptable number of samples have been collected, the average absolute deviation is computed. Such an approach is described, e.g., in “Signal Processing for Rough Road Detection,” 2010-01-06736; Published Apr. 12, 2010; Tameem Assaf, David Mathews and Sanjeev Naik, which is hereby incorporated by reference in its entirety herein.

In one embodiment, wheel speed sensor data 20 from the wheel speed sensors 17a, 17b, 17c, 17d is stored in the controller 12 and compared by a comparator module 22 to one or more wheel speed threshold values 24 to determine wither the vehicle is on a rough road. For instance, when on an unpaved road or a rough paved road (e.g., having pot holes or the like), the wheel speeds measured at respective wheel ends may not be uniform. In such cases, the processor determines that the vehicle is on a rough road and predicts that air consumption by the suspension system will increase to compensate for the unlevel terrain. In one example, the processor 14 performs a table lookup on an air consumption lookup table 26 that correlates wheel speed variation to suspension system air consumption, and, depending on the magnitude of the inconsistency of the wheel speeds at the respective wheel ends, transmits a signal providing information regarding the rough road to an electronic air charging (EAC) system 28 that controls one or more air compressors 32. The one or more air compressors provide air to, among other things, one or more suspension air bags or chambers that facilitate maintaining the vehicle in a level state. The one or more suspension air bags may be part of an electronic height control system. The one or more suspension air bags may be part of a chassis suspension system or a cab suspension system. The one or more air compressors also provide air to a pneumatically controlled seat height system and the air brake system.

The received indication comprises sensed wheel speed values from each of the plurality of wheel speed sensors, and the processor (via the comparator module) compares the wheel speed values to each other such that when the wheel speed values are determined to be non-uniform, the processor determines that the vehicle is on a rough road.

According to an example, the system facilitates adjusting air compressor duty cycle for a vehicle on a rough road wherein one or more chassis air suspension bags 34 provide load-leveling capability for the vehicle. The air compressor 32 is configured to have a first duty cycle and provides air to the one or more air suspension bags, as well as to other systems such as air brakes and the like. In one embodiment, the first duty cycle is set to ensure enough compressor ON time to keep the pressure in the system between 120 psi and 150 psi.

In another embodiment, the air compressor 32 provides air to cab air suspension bags 36, a pneumatic seat control system 40, and/or a vehicle brake system 41, in the manner described above with regard to the chassis air suspension bags.

The processor 14 is configured to receive an indication that the vehicle is on a rough road The received indication may comprise sensed wheel speed values from each of the plurality of wheel speed sensors, and the processor (via the comparator module) compares the wheel speed values to each other such that when the wheel speed values are determined to be non-uniform, the processor determines that the vehicle is on a rough road.

In response to the received indication, the EAC 28 increases a warning threshold 29 above which a driver is alerted to an over-threshold duty-cycle. For instance, a warning indication can be transmitted to an on-board display 42 for display to a driver when the warning threshold is exceeded. Once the warning threshold has been increased, the EAC 28 also increases a duty cycle setting 30 for the air compressor to a second duty cycle level that is higher than the first duty cycle level but still less than or equal to the increased warning threshold. In this manner, the driver need not be alerted to increased air consumption by the suspension system when the vehicle is compensating for rough road conditions.

In another embodiment, the received indication comprises air consumption information received from the EAC system 28, which measures air consumption directly or indirectly, and the processor 14 is further configured to determine that the vehicle is on a rough road when the measured air consumption value is above a predetermined consumption threshold above with the driver is normally alerted to the increased consumption. For instance, the EAC system can measure air consumption indirectly by monitoring the duty cycle of the air compressor and calculating an amount of air consumed. In another embodiment, the EAC system measures air consumption directly via a flow meter or the like.

In another example, the controller 12 determines a rough road and correlates the information with the EAC 28 and an electronic height control system 38. If controller 12 determines a rough road condition exists and EAC 28 and electronic height control both determine high air usage, then it is confirmed that the vehicle is on a rough road. The controllers communicate on a vehicle communications serial bus 11. For instance, the height control device 38 can be configured to transmit a control signal to the one or more air suspension bags. Upon receipt of an indication that the vehicle is on a rough road the height control device 28 adjusts an amount of dead band in the control signal in order to control a number of times the one or more air suspension bags are activated and deactivated during a period of time of receiving the indication that the vehicle is on the rough road.

In another example, the controller 12 may be a single controller that includes the functions of the EAC and the electronic height control system.

When the vehicle is determined to be on a rough road, the EAC 28 increases the warning threshold by a predetermined amount (e.g., 10% or some other predetermined amount. In another embodiment, the warning threshold increase is a function of the variation in detected wheel speeds, such that a larger variation correlates to a larger increase in the warning threshold. The duty cycle can also be increased (e.g., to 70% or some other predetermined increased level) once the warning threshold has been increased. In this manner, the increased duty cycle remains below the increased warning threshold so that the driver is not unnecessarily alerted to increased air consumption caused by the rough road conditions.

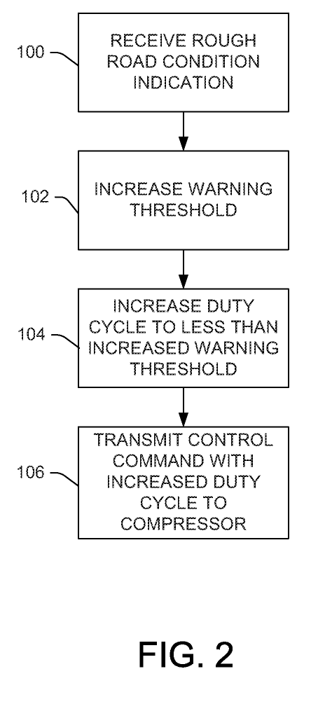

FIG. 2 illustrates a method for adjusting air compressor duty cycle for a vehicle on a rough road, in accordance with one or more features set forth herein. At 100, an indication is received that the vehicle is on a rough road. In one embodiment, the received indication comprises sensed wheel speed values from each of a plurality of wheel speed sensors, and the wheel speed values are compared to each other. When the wheel speed values are determined to be non-uniform relative to each other, it is determined that the vehicle is on a rough road. In another embodiment, the received indication comprises air consumption information received from, e.g., an electronic air charging system that measures air consumption. In this embodiment, it is determined that the vehicle is on a rough road when the measured air consumption value is above a predetermined consumption threshold. Air consumption can be measured indirectly by monitoring the duty cycle of the air compressor and calculating an amount of air consumed, or directly via a flow meter or the like.

At 102, a warning threshold is increased, above which a driver is alerted to an over-threshold duty-cycle. For instance, an initial warning threshold may be set to, e.g., 60%. In this example, if an initial (first) duty cycle is set to e.g., 58%, then when the duty cycle reaches or exceeds 60% the warning threshold is breached and an alarm is triggered to alert the driver to an over duty cycle condition or an excess air consumption condition. By increasing the warning threshold, the duty cycle can similarly be increased when on a rough road so that the increased air consumption does not trigger the alert.

Accordingly, at 104, the duty cycle of the air compressor is increased from a first duty cycle to a second duty cycle such that the second duty cycle is below the increased warning threshold. For instance, in the foregoing example, if the warning threshold is increased by 10%, e.g., from 60% to 70%, then at 104 the duty cycle can be increased up to 70%. In this case, the alarm is only triggered when the duty cycle exceeds 70%. At 106, an indication of the second duty cycle is transmitted to an air compressor providing air to the one or more air suspension bags thereby increasing the duty cycle of the air compressor.

The first duty cycle can be selected to maintain a pressure of, e.g., approximately 120 psi-150 psi in the system. When the vehicle travels along a rough road where air consumption is increased by various system components (e.g., brakes, etc.), then the duty cycle of the compressor is increased to the second duty cycle level in order to maintain the system pressure at 120 psi-150 psi. In this manner, adequate air pressure can be maintained in the system when the unexpected air demand is encountered such as when traveling on unpaved or poorly paved roads.

The herein-described method determines that the vehicle is on a rough road as a function of vehicle wheel speeds, air consumption, and/or signal received from an on board ABS system. Based on an indication that the vehicle is on a rough surface, an assumption is made that air consumption by the suspension system will increase imminently to compensate for the unlevel terrain. In one embodiment, a table lookup is performed on an air consumption lookup table that correlates wheel speed variation to suspension system air consumption, and, depending on the magnitude of the inconsistency of the wheel speeds at the respective wheel ends, a control signal is generated to increase a duty cycle for one or more air compressors that provide air to the suspension system and other vehicle components. Additionally, a warning threshold upon which an alert is generated for the driver is increased so that the increased duty cycle does not trigger false alerts to the driver.

The received indication may comprise sensed wheel speed values from each of the plurality of wheel speed sensors, and the processor (via the comparator module) compares the wheel speed values to each other such that when the wheel speed values are determined to be non-uniform, the processor determines that the vehicle is on a rough road.

According to an example, the method facilitates adjusting air compressor duty cycle for a vehicle on a rough road wherein one or more air suspension reservoirs provide load-leveling capability for the vehicle. The air compressor is configured to have a first duty cycle and provides air to the one or more air suspension bags, as well as to other systems such as air brakes and the like. In one embodiment, the first duty cycle is set to ensure enough compressor ON time to keep the pressure in the system between 120 psi and 150 psi.

An indication is received that the vehicle is on a rough road (e.g., from the ABS or by detecting non-uniform wheel speeds, etc.). The received indication may comprise sensed wheel speed values from each of the plurality of wheel speed sensors, and the processor (via the comparator module) compares the wheel speed values to each other such that when the wheel speed values are determined to be non-uniform, a processor determines that the vehicle is on a rough road.

In response to the received indication, the processor increases the warning threshold above which a driver is alerted to an over-threshold duty-cycle. For instance, a warning indication can be transmitted to an on-board display for display to a driver when the warning threshold is exceeded. Once the warning threshold has been increased, the duty cycle setting for the air compressor can also be increased to a second duty cycle level that is higher than the first duty cycle level but still less than or equal to the increased warning threshold. In this manner, the driver need not be alerted to increased air consumption by the suspension system when the vehicle is compensating for rough road conditions.

In another embodiment, the received indication comprises air consumption information received from an EAC system, which measures air consumption directly or indirectly, and the processor is further configured to determine that the vehicle is on a rough road when the measured air consumption value is above a predetermined consumption threshold above with the driver is normally alerted to the increased consumption. For instance, the EAC system can measure air consumption indirectly by monitoring the duty cycle of the air compressor and calculating an amount of air consumed. In another embodiment, the EAC system measures air consumption directly via a flow meter or the like.

When the vehicle is determined to be on a rough road, the processor increases the warning threshold by a predetermined amount (e.g., 15% or some other predetermined amount). In another embodiment, the warning threshold increase is a function magnitude of the roughness of the road, such that a greater roughness correlates to a larger increase in the warning threshold. The duty cycle can also be increased (e.g., to 70% or some other predetermined increased level) once the warning threshold has been increased. In this manner, the increased duty cycle remains below the increased warning threshold so that the driver is not unnecessarily alerted to increased air consumption caused by the rough road conditions.

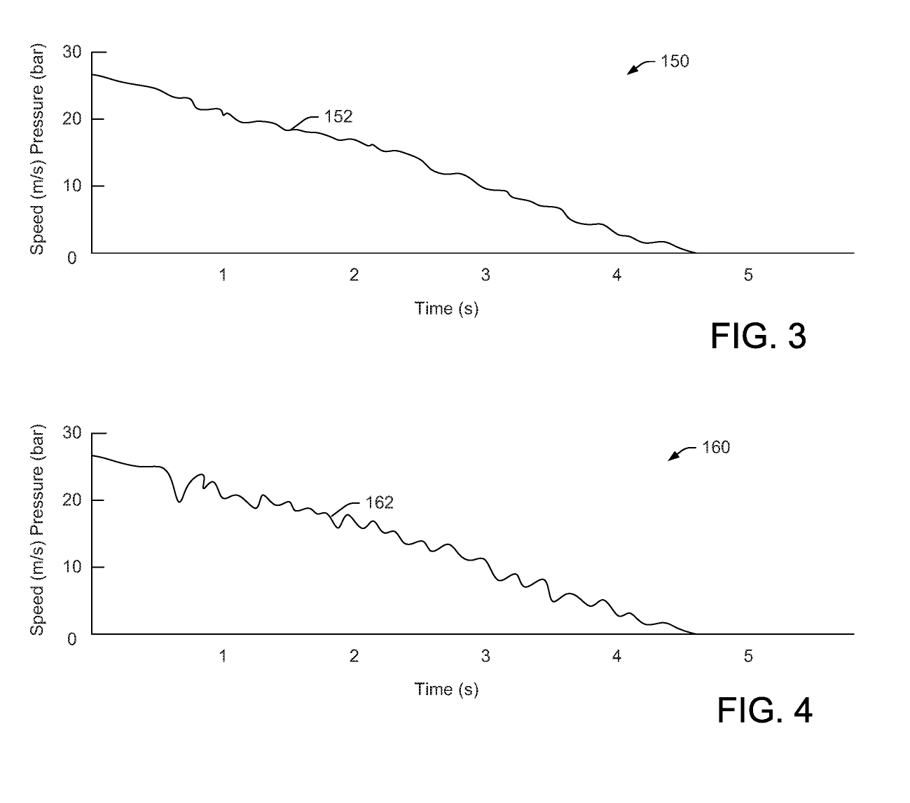

FIG. 3 illustrates a graph 150 representing speed and pressure at a wheel end as a function of time, such as can be detected by the described systems and methods and used to determine whether the vehicle is on a rough surface or a smooth surface. As is illustrated by the line 152, there is little wheel speed oscillation and thus the vehicle can be determined to be on a smooth surface.

FIG. 4 illustrates a graph 160 representing speed and pressure at a wheel end as a function of time, such as can be detected by the described systems and methods and used to determine whether the vehicle is on a rough surface or a smooth surface. As is illustrated by the plotted line 162, there is substantial wheel speed oscillation and thus the vehicle can be determined to be on a rough road surface. In one embodiment, the amount of oscillation in wheel speed as measured by one or more wheel speed sensors (FIG. 1) can be compared to a predetermined threshold oscillation value in order to determine whether the vehicle is on a rough road. If the amount of oscillation is above the threshold, then the vehicle is determined to be on a rough road and the herein-described systems and/or methods are activated.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

Having thus described the preferred embodiments, the invention is now claimed to be:

1. A system that facilitates adjusting air compressor duty cycle for a vehicle on a rough road, comprising:
one or more air suspension bags that provide load-leveling capability for the vehicle;
an air compressor having a first duty cycle and providing air to the one or more air suspension bags; and
a processor configured to:
receive an indication that the vehicle is on a rough road;
increase a warning threshold above which a driver is alerted to an over-threshold duty-cycle for the period of time of receiving an indication the vehicle is on the rough road.

2. The system according to claim 1, further comprising a plurality of wheel speed sensors, each wheel speed sensor being located at a respective wheel end, and wherein received indication comprises sensed wheel speed values from each of the plurality of wheel speed sensors.

3. The system according to claim 2, wherein the processor is further configured to:
compare the wheel speed values to each other, and when the wheel speed values are determined to be non-uniform, determine that the vehicle is on a rough road.

4. The system according to claim 1, wherein the received indication comprises air consumption information received from an electronic air charging system that measures air consumption, and wherein the processor is further configured to determine that the vehicle is on a rough road when the measured air consumption value is above a predetermined consumption threshold.

5. The system according to claim 4, wherein the electronic air charging system measures air consumption indirectly by monitoring the duty cycle of the air compressor and calculating an amount of air consumed.

6. The system according to claim 5, wherein the electronic air charging system measures air consumption directly via a flow meter.

7. The system according to claim 1, wherein the warning threshold increase is approximately 10%.

8. The system according to claim 1, wherein the increased duty cycle is less than 70%.

9. The system according to claim 1, wherein the first duty cycle is pre-selected to maintain pressure in the system between 120 psi and 150 psi.

10. The system according to claim 1, wherein the processor is further configured to transmit a warning indication to an on-board display for display to a driver.

11. The system according to claim 10, wherein the warning indication is transmitted when the warning threshold is exceeded.

12. The system according to claim 1, wherein the over-threshold duty cycle is any duty cycle above the first duty cycle.

13. The system according to claim 1, wherein the processor is further configured to increase a duty cycle of the air compressor to a second duty cycle such that the second duty cycle is below the increased warning threshold.

14. A method of adjusting air compressor duty cycle for a vehicle on a rough road, comprising:
receiving an indication that the vehicle is on a rough road;
increasing a warning threshold above which a driver is alerted to an over-threshold duty-cycle for the period of time of receiving an indication the vehicle is on the rough road.

15. The method according to claim 14, further comprising:
increasing a duty cycle of the air compressor from a first duty cycle to a second duty cycle such that the second duty cycle is below the increased warning threshold; and
transmitting an indication of the second duty cycle to an air compressor providing air to one or more air suspension bags thereby increasing the duty cycle of the air compressor.

16. The method according to claim 14, wherein the received indication comprises sensed wheel speed values from each of a plurality of wheel speed sensors, and further comprising comparing the wheel speed values to each other, and when the wheel speed values are determined to be non-uniform, determining that the vehicle is on a rough road.

17. The method according to claim 14, wherein the received indication comprises air consumption information received from an electronic air charging system that measures air consumption, and further comprising determining that the vehicle is on a rough road when the measured air consumption value is above a predetermined consumption threshold.

18. The method according to claim 17, further comprising measuring air consumption at least one of:
indirectly by monitoring the duty cycle of the air compressor and calculating an amount of air consumed; and
directly via a flow meter.

19. The method according to claim 14, wherein the warning threshold increase is approximately 10%.

20. The method according to claim 14, wherein the increased duty cycle is less than 70%.

21. The method according to claim 14, wherein the first duty cycle is pre-selected to maintain pressure in the system between 120 psi and 150 psi.

22. The method according to claim 14, further comprising transmitting a warning indication to an on-board display for display to a driver when the warning threshold is exceeded.

23. A controller configured to adjust air compressor duty cycle for a vehicle on a rough road, comprising at least one processor configured to:
receive an indication that the vehicle is on a rough road;
increase a warning threshold above which a driver is alerted to an over-threshold duty-cycle for the period of time of receiving an indication the vehicle is on the rough road.

24. The controller according to claim 23, further configured to:
increase a duty cycle of the air compressor from a first duty cycle to a second duty cycle such that the second duty cycle is below the increased warning threshold; and
transmit an indication of the second duty cycle to an air compressor providing air to one or more air suspension bags thereby increasing the duty cycle of the air compressor.

25. The controller according to claim 23, wherein the received indication comprises sensed wheel speed values from each of the plurality of wheel speed sensors, and wherein the processor is further configured to:
compare the wheel speed values to each other, and when the wheel speed values are determined to be non-uniform, determine that the vehicle is on a rough road.

26. The controller according to claim 23, wherein the received indication comprises air consumption information received from an electronic air charging system that measures air consumption, and wherein the processor is further configured to determine that the vehicle is on a rough road when the measured air consumption value is above a predetermined consumption threshold.

27. The controller according to claim 23, wherein the warning threshold increase is approximately 10%.

28. The controller according to claim 23, wherein the increased duty cycle is less than 70%.

29. The controller according to claim 23, wherein the first duty cycle is pre-selected to maintain pressure in the system between 120 psi and 150 psi.

30. The controller according to claim 23, further comprising transmitting a warning indication to an on-board display for display to a driver when the warning threshold is exceeded.

31. An apparatus for adjusting air compressor duty cycle for a vehicle on a rough road, comprising:
receiving means for receiving an indication that the vehicle is on a rough road;
means for increasing a warning threshold above which a driver is alerted to an over-threshold duty-cycle threshold for the period of time of receiving an indication the vehicle is on the rough road.

32. The apparatus according to claim 31, further comprising:
means for increasing a duty cycle of the air compressor from a first duty cycle to a second duty cycle such that the second duty cycle is below the increased warning threshold; and
transmitting means for transmitting an indication of the second duty cycle to an air compressor providing air to one or more air suspension bags thereby increasing the duty cycle of the air compressor.

33. A system that facilitates adjusting air compressor duty cycle for a vehicle on a rough road, comprising:
one or more air suspension bags that provide load-leveling capability for the vehicle;
a height control device configured to:
transmit a control signal to the one or more air suspension bags;
receive an indication that the vehicle is on a rough road;
adjust an amount of dead band in the control signal in order to control a number of times the one or more air suspension bags are activated and deactivated during a period of time of receiving the indication that the vehicle is on the rough road.
